(19) United States
(12) Patent Application Publication
(10) Pub. No.: US 2006/0010403 A1
(43) Pub. Date: Jan. 12, 2006

(54) Portable multimedia device

(76) Inventor: Seong-Man Jeon, Seoul (KR)

Correspondence Address: MCKENNA LONG & ALDRIDGE LLP;Song K. Jung, 1900 K Street, N.W., Washington, DC, 20006, US

(21) Appl. No.: 11/153,387

(22) Filed: Jun. 16, 2005

(30) Foreign Application Priority Data
Jun. 18, 2004 (KR) 2004-0045670

(51) Int. Cl. G06F 17/00

(52) U.S. Cl. 715/864

(57) ABSTRACT

A portable multimedia device is provided that includes a video output unit for displaying images, an audio output unit overlapping a portion of the video output unit, and a driver circuit unit for operating the video output unit and the audio output unit. The video output unit includes a liquid crystal panel. The audio output unit includes at least one speaker module including an electromagnet and a diaphragm.

The present invention claims the benefit of Korean Patent Application No. 2004-0045670 filed on Jun. 18, 2004, which is hereby incorporated by reference for all purposes as if fully set forth herein.

### BACKGROUND OF THE INVENTION

1. Field of the Invention

The present invention relates to a multimedia module and more particularly, to a portable multimedia device with a combined image and sound region.

2. Discussion of the Related Art

The advancement of science and technology has resulted in the development of a variety of small sized devices. These small-sized devices include multimedia players capable of playing various types of media, for example, video, audio and the like. These portable multimedia devices have been incorporated into various other devices, for example wireless internet phones and/or personal digital assistants (PDAs) that include information retrieval functions as well as act as phones.

FIG. 1 illustrates a portable multimedia device according to the related art. In FIG. 1, the related art portable multimedia device 10 includes a video output unit 12, for example, a monitor screen, for displaying still and moving images, and an audio output unit 14, for example, a speaker, for providing sounds to support the displayed images. The video output unit 12 and the audio output unit 14 are positioned close to each other, but do not overlap. In general, stereophonic sound is provided by forming two channels, that is, two speakers, on left and right or upper and lower sides of the video output unit 12 on the same plane.

In the portable multimedia device, since the audio output unit is disposed on the same plane as the video output unit, an area for the video output unit may be reduced, and the size of the device may be increased.

### SUMMARY OF THE INVENTION

Accordingly, the present invention is directed to a portable multimedia device that substantially obviates one or more problems due to limitations and disadvantages of the related art.

An advantage of the present invention is to provide a portable multimedia device that more efficiently utilizes space.

Another advantage of the present invention is to provide a portable multimedia device that has a compact size and reduced manufacturing costs.

Additional features and advantages of the invention will be set forth in the description which follows, and in part will be apparent from the description, or may be learned by practice of the invention. The advantages of the invention will be realized and attained by the structure particularly pointed out in the written description and claims hereof as well as the appended drawings.

To achieve these and other advantages and in accordance with the purpose of the present invention, as embodied and broadly described, a portable multimedia device is provided, comprising: a video output unit; an audio output unit overlapping a portion of the video output unit; and a driver circuit unit operating the video output unit and the audio output unit.

In another aspect of the present invention, a portable multimedia device is provided, comprising: a liquid crystal panel including an active area in which images are displayed; at least one speaker module overlapping a portion of the liquid crystal panel, the at least one speaker module including an electromagnet and a diaphragm; and a driver circuit unit controlling the liquid crystal panel and the at least one speaker module.

In another aspect of the present invention, a method of manufacturing a portable multimedia device is provided, comprising: forming a liquid crystal panel including an active area; forming a first speaker module overlapping a portion of the liquid crystal panel, the first speaker module including an electromagnet and a diaphragm; and forming a driver circuit unit controlling the liquid crystal panel and the at least one speaker module.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view of a portable multimedia device according to the related art;

FIG. 2 is a schematic view of a portable multimedia device according to an embodiment of the present invention;

FIG. 3 is a cross-sectional view of a portable multimedia device according to an embodiment of the present invention; and

FIG. 4 is a schematic view of a portable multimedia device according to another embodiment of the present invention.

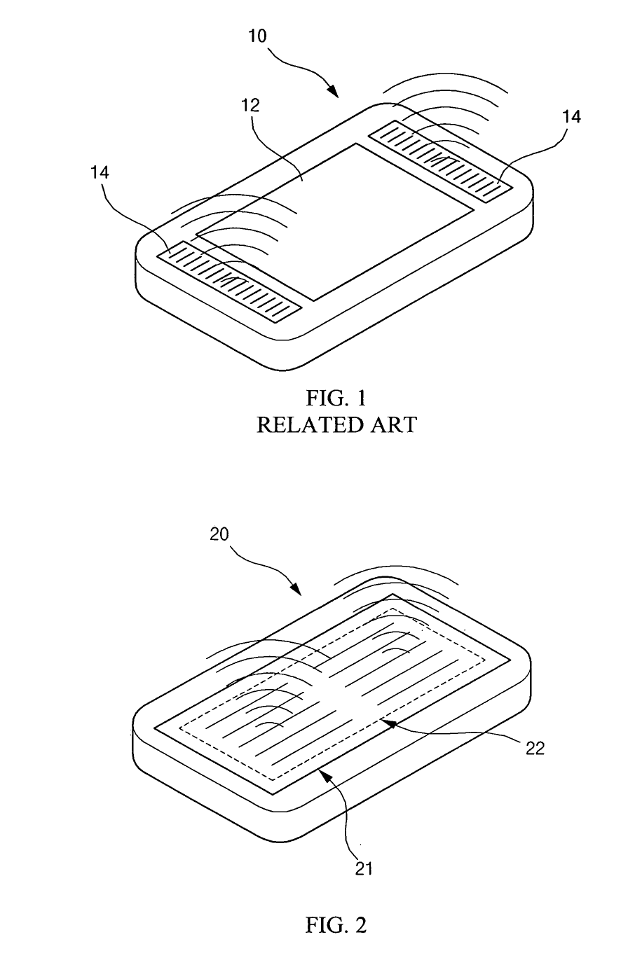

### DETAILED DESCRIPTION OF THE ILLUSTRATED EMBODIMENTS

Reference will now be made in detail to embodiments of the present invention, examples of which are illustrated in the accompanying drawings.

FIG. 2 is a schematic view of a portable multimedia device according to an embodiment of the present invention. As illustrated in FIG. 2, the portable multimedia device 20 includes a video output unit 21 and an audio output unit 22. The audio output unit 22 overlaps the video output unit 21 in a cross-sectional view. Therefore, the area of the video output unit 21 may be increased compared to the same sized device of the related art. In addition, the device having the above structure may be applied in more fields.

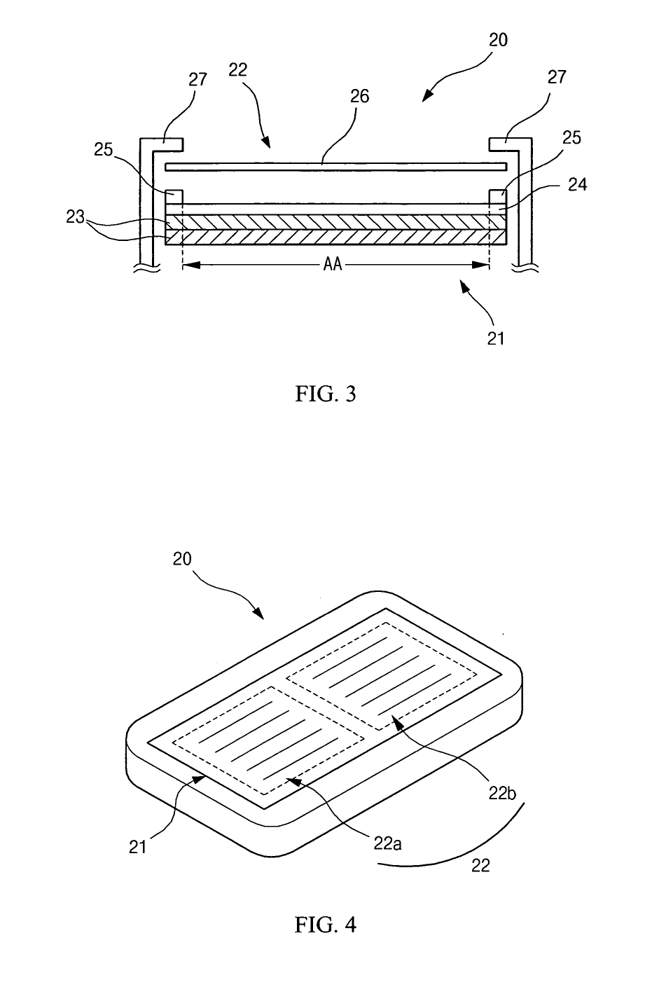

FIG. 3 is a cross-sectional view of a portable multimedia device according to an exemplary embodiment of the present invention. In FIG. 3, the portable multimedia device 20 includes a video output unit 21, an audio output unit 22, and a driver circuit unit.

The video output unit 21 includes a liquid crystal panel 23 for displaying images and a polarizer 24 over the liquid crystal panel 23. The liquid crystal panel 23 is composed of two substrates and a liquid crystal layer interposed there between. The liquid crystal panel 23 has an active area AA, in which images are shown. Although not shown in FIG. 3, another polarizer and a reflective layer may be disposed under the liquid crystal panel 23 and opposite the polarizer 24.

The audio output unit 22 substantially overlaps the entire video output unit. A planar type speaker module may be used as the audio output unit 22 for outputting sounds. The speaker module includes at least one electromagnet 25 and a planar diaphragm 26. The at least one electromagnet 25 receives sound source currents, which are generated according to the audio information to be output. The at least one electromagnet 25 is positioned over the polarizer 24 and surrounds the active area AA so that the images may be displayed without hindrance. The diaphragm 26 is positioned over and spaced apart from the electromagnet 25. The diaphragm 26 is formed of a transparent conductive material and receives currents. Because the diaphragm 26 is transparent, images displayed in the active area AA are viewable through the diaphragm 26.

Reference currents are fed to the diaphragm 26, and a magnetic field is produced in the diaphragm 26. Another magnetic field is produced in the electromagnet 25 due to the sound source currents. Thus, the speaker module outputs vibrations of the diaphragm 26, which are caused by interaction between the magnetic fields, as sound source.

The driver circuit unit (not shown) for operation of the portable multimedia device 20 is disposed under or at a side of the liquid crystal panel 23. The driver circuit unit operates both the liquid crystal panel 23 and the speaker module.

The portable multimedia device 20 further includes a hard case 27 that partially covers and protects the above-mentioned units.

In the present invention, because the audio output unit overlaps the video output unit, space for the video output unit is efficiently utilized, and the portable multimedia device may remain compact in the size.

FIG. 4 is a schematic view of a portable multimedia device according to another embodiment of the present invention. As illustrated in FIG. 4, the portable multimedia device 20 includes a video output unit 21 and an audio output unit 22 including two speaker modules 22a and 22b. The video output unit 21 may have the same structure as that illustrated in FIG. 3. The speaker modules 22a and 22b are spaced apart from each other and overlap the video output unit 21. Each of the speaker modules 22a and 22b also has the same structure as that illustrated in FIG. 3. Accordingly, stereophonic sound is provided due to the two speaker modules 22a and 22b.

The portable multimedia device may be a folder-type. If the portable multimedia device includes two speaker modules, the portable multimedia device may be folded along the border portion between the speaker modules.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A portable multimedia device, comprising:
a video output unit;
an audio output unit overlapping a portion of the video output unit; and
a driver circuit unit operating the video output unit and the audio output unit.

2. The device according to claim 1, wherein the video output unit includes a liquid crystal display panel.

3. The device according to claim 1, wherein the audio output unit includes at least one speaker module.

4. The device according to claim 3, wherein the audio output unit includes two speaker modules.

5. The device according to claim 1, wherein the audio output unit substantially overlaps the entire video output unit.

6. A portable multimedia device, comprising:
a liquid crystal panel including an active area in which images are displayed;
at least one speaker module overlapping a portion of the liquid crystal panel, the at least one speaker module including an electromagnet and a diaphragm; and
a driver circuit unit controlling the liquid crystal panel and the at least one speaker module.

7. The device according to claim 6, further comprising a case partially covering the liquid crystal panel and the at least one speaker module.

8. The device according to claim 6, wherein the electromagnet is positioned outside the active area.

9. The device according to claim 6, wherein the diaphragm is transparent.

10. The device according to claim 6, wherein the portable multimedia device includes two speaker modules.

11. The device according to claim 10, wherein the two speaker modules are spaced apart from each other.

12. The device according to claim 6, further comprising:
a polarizer between the liquid crystal panel and the at least one speaker module.

13. A method of manufacturing a portable multimedia device, the method comprising:
forming a liquid crystal panel including an active area;
forming a first speaker module overlapping a portion of the liquid crystal panel, the first speaker module including an electromagnet and a diaphragm; and
forming a driver circuit unit controlling the liquid crystal panel and the at least one speaker module.

14. The device according to claim 13, further comprising:
forming a case partially covering the liquid crystal panel and the first speaker module.

15. The device according to claim 13, wherein the electromagnet is positioned outside the active area.

16. The device according to claim 13, wherein the diaphragm is transparent.

17. The device according to claim 13, further comprising:
forming a second speaker module spaced apart from the first speaker module.

18. The device according to claim 13, further comprising:
forming a polarizer between the liquid crystal panel and the first speaker module.
